(19) United States
(12) Patent Application Publication
(10) Pub. No.: US 2024/0297301 A1
(43) Pub. Date: Sep. 5, 2024

(54) SILICON-BASED COMPOSITE MATERIALS, LITHIUM-ION BATTERY ANODES, LITHIUM-ION BATTERIES, AND PREPARING METHODS THEREOF

(71) Applicant: CHANGZHOU UNIVERSITY, Changzhou (CN)

(72) Inventors: Yurong REN, Changzhou (CN); Hongshun ZHAO, Changzhou (CN); Jianbin LI, Changzhou (CN)

(73) Assignee: CHANGZHOU UNIVERSITY, Changzhou (CN)

(21) Appl. No.: 18/641,471

(22) Filed: Apr. 22, 2024

Related U.S. Application Data
(63) Continuation of application No. PCT/CN2023/087771, filed on Apr. 12, 2023.

(30) Foreign Application Priority Data
May 7, 2022 (CN) 202210492168.3

(51) Int. Cl. H01M 4/36; C01B 32/956; C01G 29/00; H01M 4/02; H01M 4/1391; H01M 4/1395; H01M 4/38; H01M 4/485; H01M 4/62; H01M 10/0525

(52) U.S. Cl. CPC H01M 4/366; C01B 32/956; C01G 29/006; H01M 4/1391; H01M 4/1395; H01M 4/386; H01M 4/485; H01M 4/625; H01M 10/0525; C01P 2004/03; C01P 2004/04; C01P 2006/40; H01M 2004/027

(57) ABSTRACT

Silicon-based composite material is provided, comprising a co-blended material having a porous structure, a sodium bismuth titanate (Bi_{0.5}Na_{0.5}) TiO₃ piezoelectric material encapsulated on the surface of the co-blended material, and the co-blended material comprising a co-blended porous Si/C material and a multi-walled carbon nanotube. The silicon-based composite material has a porous structure that provides a multi-path transport channel for lithium ions and provides an effective buffer space for the volume expansion of the silicon; the conductive network constituted by the multi-walled carbon nanotubes CNTs is conducive to enhanced electron transfer which enables excellent reaction kinetics; the network structure composed of CNTs helps lithium ions to maintain structural stability in the process of de-embedded lithium, which in turn maintains high capacity at high currents and has high stability. The external stimulation of the sodium bismuth titanate (Bi_{0.5}Na_{0.5})TiO₃ piezoelectric material always presents and the function does not fail to maintain good interfacial contact and promote interfacial lithium-ion transport capacity more effectively.

### CROSS-REFERENCE TO RELATED APPLICATIONS

This application is a Continuation of International Application No. PCT/CN2023/087771, filed on Apr. 12, 2023, which claims priority to Chinese Patent Application No. 202210492168.3, filed on May 7, 2022, the entire contents of each of which are hereby incorporated by reference.

### TECHNICAL FIELD

The present disclosure relates to the field of lithium-ion battery, and in particular relates to a silicon-based composite material, a lithium-ion battery anode, a lithium-ion battery, and a preparing method thereof.

### BACKGROUND

Secondary batteries are a typical representative of green electrochemical energy, which plays an important role in daily life. In a variety of secondary batteries, lithium-ion batteries, with the advantages of a low self-discharge, a high energy density, and a wider working voltage window, have been massively applied to a variety of portable electronic components, power automobiles, and so on.

Currently, anode materials of commercialized lithium-ion batteries are dominated by graphite. However, its theoretical specific capacity is 372 mAh g⁻¹, which has limited its industrial practical application. Therefore, the search for high-specific-capacity anode materials used to replace the graphite has become a hotspot in the research and development of lithium-ion batteries. Silicon anodes have received widespread attention due to its low cost, higher theoretical specific capacity (4200 mAh g⁻¹, Li_{4.4}Si), and lower working voltage (0.37 V vs. Li/Li⁺), among which silicon carbon alloy (Si/C) has the advantages of good mechanical properties and chemical stability, which is more likely to meet the requirements of future new energy automobiles and portable wearable energy storage devices for the batteries with high energy density, high power density, and light weight. However, the Si/C anodes have the disadvantages of poor electrical conductivity, slow reaction kinetics, and significant volume expansion (up to 300%), and thus have limited practical applications in the field of electrochemical energy.

Therefore, there is a need to provide out a silicon-based composite material, a lithium-ion battery, an anode material of the lithium-ion battery and a preparation method thereof, so as to enable the lithium-ion battery to be more widely used in the future.

### SUMMARY

Embodiments of the present disclosure provide a silicon-based composite material comprising a co-blended material having a porous structure, a sodium bismuth titanate (Bi_{0.5}Na_{0.5}) TiO₃ piezoelectric material encapsulated on a surface of the co-blended material, and the co-blended material including a co-blended porous Si/C material and multi-walled carbon nanotubes.

In some embodiments, the silicon-based composite material includes, in mass ratio, 5-20% of the sodium bismuth titanate (Bi_{0.5}Na_{0.5}) TiO₃ piezoelectric material, 30% of the multi-walled carbon nanotubes, and 65-90% of the porous Si/C material.

Embodiments of the present disclosure provide a method for preparing a silicon-based composite material, comprising:

S1, performing a ball milling a Si/C material with a ball mill for 12-16 h to obtain the porous Si/C material for use.

S2, mixing acidified multi-walled carbon nanotubes with the porous Si/C material obtained from step S1, and then performing the ball milling for 5-8 h to obtain the co-blended material.

S3, mixing the sodium bismuth titanate (Bi_{0.5}Na_{0.5}) TiO₃ piezoelectric material with the co-blended material obtained from step S2, and then performing the ball milling for 2-4 h to obtain the silicon-based composite material.

In some embodiments, in step S2, a feeding mass ratio of the porous Si/C material to the multi-walled carbon nanotubes is (8-10): 1.

In some embodiments, in step S3, a feeding mass ratio of the sodium bismuth titanate (Bi_{0.5}Na_{0.5}) TiO₃ piezoelectric material to the co-blended material is 1: (4-19).

In some embodiments, the ball milling steps in steps S1, S2, and S3 are carried out under an inert gas atmosphere.

In some embodiments, in the ball milling step of steps S1, S2, and S3, a ball material ratio is (20-30):1 and a rotational speed of the ball mill is 700-900 revolutions per minute (rpm).

In some embodiments, after the ball milling in steps S1, S2, and S3, the method further comprises a step of sieving.

In some embodiments, the sodium bismuth titanate (Bi_{0.5}Na_{0.5}) TiO₃ piezoelectric material is prepared by a process including: adding Bismuth nitrate pentahydrate, Sodium nitrate, and Tetrabutyl titanate to NaOH and stirring uniformly, performing a hydrothermal reaction at 150-170° C. for 40-60 h, and obtaining the sodium bismuth titanate (Bi_{0.5}Na_{0.5}) TiO₃ piezoelectric material.

In some embodiments, a feeding molar ratio of the Bismuth nitrate pentahydrate, the Sodium nitrate and the Tetrabutyl titanate is (1-2):(2-3):1.

Embodiments of the present disclosure provide anode material of a lithium-ion battery, comprising the silicon-based composite material as described above, or the silicon-based composite material obtained by the preparation method as described above.

Embodiments of the present disclosure provide a method for preparing anode material of a lithium-ion battery, comprising: dispersing the silicon-based composite material, a conductive agent and a binder in water according to a mass ratio of (7-9):1:1 to obtain a mixed dispersion, coating the mixed dispersion on a copper foil, and drying the mixed dispersion to obtain the anode material.

Embodiments of the present disclosure provide a lithium-ion battery comprising the anode material as described above or the anode material obtained by the preparation method as described above.

### BRIEF DESCRIPTION OF THE DRAWINGS

This description will be further explained in the form of exemplary embodiments, which will be described in detail by means of accompanying drawings. These embodiments are not restrictive, in which the same numbering indicates the same structure, wherein:

FIG. 1 is an SEM image illustrating a silicon-based composite material according to Embodiment 2 of the present disclosure;

FIG. 2 is a cross-sectional topographic diagram illustrating a silicon-based composite material tested using a focused ion beam, according to Embodiment 2 of the present disclosure;

FIG. 3 is a TEM image illustrating a silicon-based composite material according to Embodiment 2 of the present disclosure;

FIG. 4 is a comparison diagram illustrating charge/discharge test results of a lithium-ion battery in Embodiment 2 and a lithium-ion battery in Comparative Embodiment 1 of the present disclosure;

FIG. 5 is a schematic diagram of a surface cladding structure of an anode material of a lithium-ion battery having a piezoelectric effect according to some embodiments of the present disclosure.

### DETAILED DESCRIPTION

In order to make the technical problem to be solved, the technical solution and the beneficial effect of the present disclosure clearer and more understandable, the technical solution of the present disclosure will be described below in conjunction with embodiments. It should be understood that the specific embodiments described herein are only for explaining the present disclosure, and are not intended to limit the present disclosure.

Graphite anodes of commercial lithium-ion batteries have a low theoretical specific capacity, while silicon (Si), which has a theoretical specific capacity 10 times higher than that of graphite, is considered an ideal anode material for the development of lithium-ion batteries and has attracted great attention. Although commercially available Si/C anodes have low-cost, they have poor electrical conductivity, slow response and obvious volume expansion, which are not ideal for practical applications.

Embodiments of the present disclosure provide a silicon-based composite material comprising a co-blended material having a porous structure, a sodium bismuth titanate (Bi_{0.5}Na_{0.5}) TiO₃ piezoelectric material encapsulated on a surface of the co-blended material, and the co-blended material including a co-blended porous Si/C material and multi-walled carbon nanotubes.

In some embodiments, the silicon-based composite material includes, in a mass ratio, 5-20% of the sodium titanate (Bi_{0.5}Na_{0.5}) TiO₃ piezoelectric material, 5-30% of the multi-walled carbon nanotubes, and 65-90% of the porous Si/C material.

Embodiments of the present disclosure provide a method for preparing a silicon-based composite material, comprising following operations.

S1, performing a ball milling a Si/C material with a ball mill for 12-16 h to obtain the porous Si/C material for use. S2, mixing acidified multi-walled carbon nanotubes with the porous Si/C material obtained from step S1, and then performing the ball milling for 5-8 h to obtain the co-blended material.

In some embodiments, in step S2, a feeding mass ratio of the porous Si/C material to the multi-walled carbon nanotubes may be (8-10): 1. In some embodiments, in step S2, the feeding mass ratio of the porous Si/C material to the multi-walled carbon nanotubes may be 10:1, 9:1, 8:1.

S3, mixing the sodium bismuth titanate (Bi_{0.5}Na_{0.5}) TiO₃ piezoelectric material with the co-blended material obtained in step S2, and then performing the ball milling for 2-4 h to obtain the silicon-based composite material.

In some embodiments, in step S3, a feeding mass ratio of the sodium bismuth titanate (Bi_{0.5}Na_{0.5}) TiO₃ piezoelectric material to the co-blended material may be 1: (4-19). In some embodiments, in step S3, the feeding mass ratio of the sodium bismuth titanate (Bi_{0.5}Na_{0.5}) TiO₃ piezoelectric material to the co-blended material may be 1:4, 1:9, 1:19.

In some embodiments, the ball milling in steps S1, S2, and S3 are carried out under an inert gas atmosphere. In some embodiments, the inert gas may be argon. In some embodiments, in the ball milling of steps S1, S2, and S3, a ball material ratio may be (20-30):1. In some embodiments, in the ball milling of steps S1, S2, and S3, a ball material ratio may be 15:1, 25:1.

In some embodiments, in the ball milling of steps S1, S2, and S3, a rotational speed of the ball mill is 700-900 rpm. In some embodiments, in the ball milling of steps S1, S2, and S3, the rotational speed of the ball mill may be 800 rpm.

In some embodiments, after the ball milling in steps S1, S2, and S3, the method further comprises a step of sieving.

In some embodiments, the sodium bismuth titanate (Bi_{0.5}Na_{0.5}) TiO₃ piezoelectric material is prepared by a process including: adding Bismuth nitrate pentahydrate, Sodium nitrate, and Tetrabutyl titanate to NaOH and stirring uniformly, performing a hydrothermal reaction at 150-170° C. for 40-60 h, and obtaining the sodium bismuth titanate (Bi_{0.5}Na_{0.5}) TiO₃ piezoelectric material.

In some embodiments, a feeding molar ratio of the Bismuth nitrate pentahydrate, the Sodium nitrate, and the Tetrabutyl titanate is (1-2):(2-3):1.

Embodiments of the present disclosure provide an anode material of a lithium-ion battery, comprising the silicon-based composite material described above.

Embodiments of the present disclosure provide a method for preparing an anode material of a lithium-ion battery, comprising: dispersing a silicon-based composite material, a conductive agent, and a binder in water according to a mass ratio of (7-9):1:1 to obtain a mixed dispersion, coating the mixed dispersion on a copper foil, and drying the mixed dispersion coated on the copper foil to obtain the anode material.

The present disclosure also provides a lithium-ion battery comprising the anode material described above or the anode material obtained by the preparation method described above.

The beneficial effects of the embodiments of the present disclosure include, but are not limited to: (1) the porous Si/C material is used as a substrate, which ensures a high specific capacity of the anode material; (2) the porous structure provides a multi-path transport channel for lithium ions and an effective buffer space for the volume expansion of silicon; (3) a conductive network constituted by the multi-walled carbon nanotubes (CNTs) facilitates the enhancement of electron transfer, resulting in excellent reaction kinetics; (4) at the same time, the network structure constituted by the CNTs helps lithium ions to maintain structural stability during the process of de-embedded lithium, which in turn maintains a high capacity at high currents and a high stability; (5) a ferroelectricity of the lithium titanate battery can accelerate lithium ion transport by forming a localized micro electric field in situ during the charging and discharging process; (6) the lithium titanate battery can use a mechanical stress generated by a volume expansion of an alloying reaction to form a piezoelectric potential, which can regulate lithium ion transport, and this volume expansion has been accompanied by the entire charging and discharging process, the external stimulation of this architectural material has always existed, and the function does not fail, so as to maintain a good interfacial contact, and to promote interfacial lithium ion transport capacity more effectively.

The present disclosure is described in further detail below in conjunction with specific embodiments, but the present disclosure is not limited to the following embodiments. The implementation conditions adopted in the embodiments may be further adjusted according to the different requirements for specific use, and the unspecified implementation conditions are conventional conditions in the industry.

In each of the following embodiments, the sodium bismuth titanate (Bi_{0.5}Na_{0.5}) TiO₃ piezoelectric material and the multi-walled carbon nanotubes were prepared and pretreated as follows:

1. The sodium bismuth titanate (Bi_{0.5}Na_{0.5}) TiO₃ piezoelectric material was prepared in the same way, including the following steps:
(1) A solution of Bi(NO₃)₃·5H₂O was obtained by dissolving 5.82 g Bi(NO₃)₃·5H₂O in 60 mL deionized water and stirring for 15 min;
(2) 8.16 mL of Ti(OC₄H₉)₄ solution was added dropwise to the Bi(NO₃)₃·5H₂O solution to obtain a mixed solution;
(3) 10 mL NaOH at a concentration of 12 M was added to the mixed solution with continued stirring for 30 min and the reaction was held at 150° C. for 24 h. Finally, the precipitate was collected by centrifugation and freeze-dried for 72 h to obtain the sodium bismuth titanate (Bi_{0.5}Na_{0.5})TiO₃ piezoelectric material for use.

2. Acidification of the multi-walled carbon nanotubes: Sulfuric acid and nitric acid with a volume ratio of 3:1 were mixed to obtain a mixed acid; the carbon nanotubes were subjected to ultrasonication for 1 h using the above mixed acid, and pumped for filtration, and the acidified multi-walled carbon nanotubes were obtained and reserved for use.

### Embodiment 1

Embodiment 1 of the present disclosure provides a method for preparing a silicon-based composite material, comprising:
S1, a Si/C material was ball milled with a ball mill for 16 h under an argon atmosphere at a ball material ratio of 25:1 and a rotational speed of 800 rpm, and a product was sieved and collected after ball milling to obtain 90 g porous Si/C material for use;
S2, 10 g acidified multi-walled carbon nanotubes were mixed with the porous Si/C material obtained in step S1 at a mass ratio of 9:1, and then ball milling was performed for 5 h under an argon atmosphere (the ball material ratio was 25:1, and the rotational speed of the ball mill was 800 rpm), and the co-blended material was obtained by sieving;
S3, 2 g sodium bismuth titanate (Bi_{0.5}Na_{0.5}) TiO₃ piezoelectric material was mixed with 38 g co-blended material Si/C@CNTs obtained from step S2 at a mass ratio of 1:19 (a mass ratio of the sodium bismuth titanate (Bi_{0.5}Na_{0.5}) TiO₃ piezoelectric material to the silicon-based composite material was 5%), and then ball milling was performed under the argon atmosphere with the ball mill for 3 h (the ball material ratio was 15:1, and the rotational speed of the ball mill was 800 rpm), and 5% silicon-based composite material was obtained after sieving.

Embodiment 1 of the present disclosure further provides a lithium-ion battery comprising an anode material, the anode material including the silicon-based composite material as described above. The preparation methods of the lithium-ion battery are using methods known in the field, which are not specifically limited in the present disclosure.

The following is an example to illustrate:

(1) A method for preparing an anode material, comprising the following steps: dispersing the silicon-based composite material, superconducting carbon, and sodium carboxymethyl cellulose obtained from the above preparation in water according to a mass ratio of 8:1:1, obtaining a mixed dispersion, and then coating the mixed dispersion on a foil, and drying to obtain the anode material.

(2) Using the anode material as a working electrode, a high-purity lithium foil as a counter electrode, and Celgard 2400 as a diaphragm, 1 M LiPF₆ was dissolved in ethylene carbonate (EC)/dimethyl carbonate (DMC)/ethylmethyl carbonate (EMC) (1:1:1 vol), and 10 wt % of fluorinated ethylene carbonate (FEC) was added as the electrolyte and assembled into a 2032-type coin cell in a glove box (H₂O<0.01 ppm, O₂<0.01 ppm) containing high-purity argon gas (99.999%), to obtain the lithium-ion battery.

The charging and discharging experiments of the lithium-ion battery in the present disclosure are performed on the Sunway Battery Test System.

### Embodiment 2

The present disclosure provides a method for preparing a silicon-based composite material and a method for preparing an anode material of a lithium-ion battery in Embodiment 2, and the preparation steps are basically the same as those of Embodiment 1, with the difference that, in Step S3, 2 g sodium bismuth titanate (Bi_{0.5}Na_{0.5}) TiO₃ piezoelectric material and 18 g co-blended material obtained from Step S2 were mixed in accordance with a mass ratio of 1:9 (the mass ratio of the sodium bismuth titanate (Bi_{0.5}Na_{0.5}) TiO₃ piezoelectric material to the silicon-based composite material was 10%) to obtain 10% silicon-based composite material.

### Embodiment 3

The present disclosure provides a method for preparing a silicon-based composite material and a method for preparing an anode material of a lithium-ion battery in Embodiment 3, which is basically the same as Embodiment 1, with the difference that in Step S3, 2 g sodium bismuth titanate (Bi_{0.5}Na_{0.5}) TiO₃ piezoelectric material and 11.3 g co-blended material obtained from Step S2 were mixed in accordance with a mass ratio of 15:85 (the mass ratio of the sodium bismuth titanate (Bi_{0.5}Na_{0.5}) TiO₃ piezoelectric material to the silicon-based composite material was 15%), and 15% silicon-based composite material was obtained.

### Embodiment 4

The present disclosure provides a method for preparing a silicon-based composite material and a method for preparing an anode material of a lithium-ion battery in Embodiment 4, and the preparation steps are basically the same as those of Embodiment 1, with the difference that, in step S3, 2 g sodium bismuth titanate (Bi_{0.5}Na_{0.5}) TiO₃ piezoelectric material and 8 g co-blended material obtained in step S2 were mixed in accordance with a mass ratio of 2:8 (the mass ratio of the sodium bismuth titanate (Bi_{0.5}Na_{0.5}) TiO₃ piezoelectric material to the silicon-based composite material was 20%), and 20% of the silicon-based composite material was obtained.

### Embodiment 5

The present disclosure provides a method for preparing a silicon-based composite material and a method for preparing an anode material of a lithium-ion battery in Embodiment 5. The preparation steps are basically the same as those of Embodiment 1, with the difference that in step S2, 80 g porous Si/C material and 10 g multi-walled carbon nanotubes were mixed in a mass ratio of 8:1.

### Embodiment 6

The present disclosure provides a method for preparing a silicon-based composite material and a method for preparing an anode material of a lithium-ion battery in Embodiment 6. The preparation steps are basically the same as those of Embodiment 1, with the difference that in step S2, 90 g porous Si/C material and 9 g multi-walled carbon nanotubes were mixed in a mass ratio of 10:1.

### Comparative Embodiment 1

The present disclosure provides a method for preparing a composite electrode material in Comparative Embodiment 1, comprising the following steps:
S1, Si/C material was ball milled under an argon atmosphere with a ball mill for 16 hours at a ball material ratio of 25:1 and a rotational speed of 800 rpm, and a product was sieved and collected after ball milling to obtain 90 g porous Si/C material for use;
S2, 10 g acidified multi-walled carbon nanotubes and the porous Si/C material obtained in step S1 were mixed in a mass ratio of 9:1, and then ball milling was performed under an argon atmosphere for 5 hours (the ball material ratio was 25:1, and the rotational speed of the ball mill was 800 rpm), and the co-blended material was obtained by sieving.

The present disclosure in Comparative Embodiment 1 further provides a lithium-ion battery comprising an anode material, the anode material including the silicon-based composite material of Embodiment 1. The lithium-ion battery is prepared using methods known in the field and is not specifically limited in the present disclosure.

One embodiment of a method for preparing a lithium-ion battery may be seen in the relevant part of Embodiment 1.

The charging and discharging experiments of the lithium-ion battery in the present disclosure are performed on the Sunway Battery Test System.

### Comparative Embodiment 2

The present disclosure provides a method for preparing a silicon-based composite material and a method of preparing an anode material of a lithium-ion battery in Comparative embodiment 2. The preparation steps are basically the same as those of Embodiment 1, with the difference that there was no ball milling process in steps S1, S2, and S3.

### Comparative Embodiment 3

The present disclosure provides a method for preparing a silicon-based composite material and a method of preparing an anode material of a lithium-ion battery in Comparative embodiment 3. The preparation steps are basically the same as those of Embodiment 1, with the difference that, in Step S3, 2 g sodium bismuth titanate (Bi_{0.5}Na_{0.5}) TiO₃ piezoelectric material and 65 g co-blended material obtained in Step S2 were mixed (the mass ratio of the sodium bismuth titanate (Bi_{0.5}Na_{0.5}) TiO₃ piezoelectric material to the silicon-based composite material was 3%).

### Comparative Embodiment 4

The present disclosure provides a method for preparing a silicon-based composite material and a method for preparing an anode material of a lithium-ion battery in Comparative embodiment 4. The preparation steps are basically the same as those in Embodiment 1, with the difference that, in Step S3, 2 g sodium bismuth titanate (Bi_{0.5}Na_{0.5}) TiO₃ piezoelectric material and 6 g co-blended material obtained in Step S2 (the mass ratio of the sodium bismuth titanate (Bi_{0.5}Na_{0.5}) TiO₃ piezoelectric material to the silicon-based composite material was 25%).

The lithium-ion batteries obtained in Embodiments 1-6 and Comparative embodiments 1-4 are subjected to charging and discharging experiments on the Sunway battery test system using a constant current charging and discharging test criterion, and the following results were obtained:

| | After 100 cycles at 200 mA g⁻¹ | |
|---|---|---|
| | Specific capacity of | Capacity |
| | discharge (mA g⁻¹) | retention (%) |
| Embodiment 1 | 678.4 | 70.03 |
| Embodiment 2 | 780.9 | 85.70 |
| Embodiment 3 | 634.7 | 67.52 |
| Embodiment 4 | 694.1 | 71.09 |
| Embodiment 5 | 700.5 | 72.16 |
| Embodiment 6 | 713.7 | 75.82 |
| Comparative Embodiment 1 | 582.5 | 50.09 |
| Comparative Embodiment 2 | 471.6 | 43.18 |
| Comparative Embodiment 3 | 600.4 | 54.52 |
| Comparative Embodiment 4 | 612.8 | 56.74 |

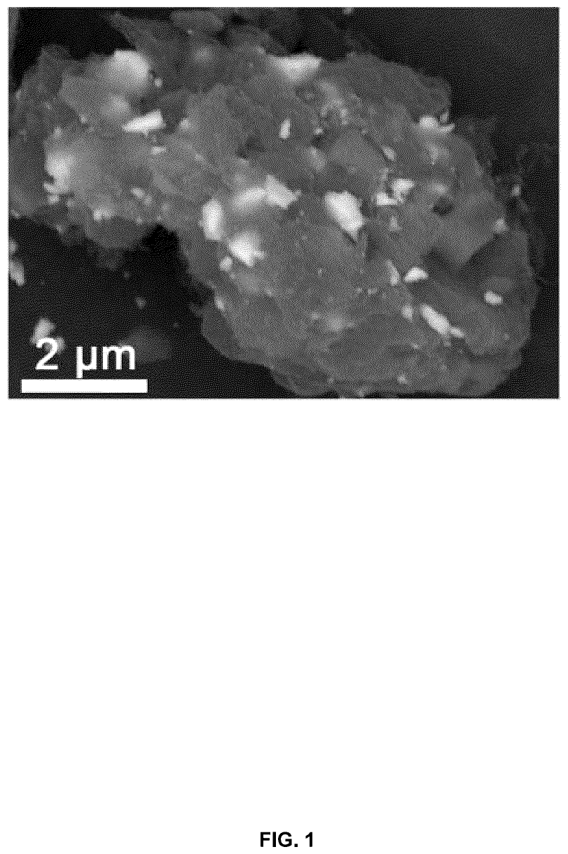

FIGS. 1-4 are all diagrams of Embodiment 2 of the present disclosure:

As shown in the SEM image of FIG. 1, the sodium bismuth titanate (Bi_{0.5}Na_{0.5}) TiO₃ piezoelectric material is clearly observed to be tightly encapsulated on the porous Si/C material. Limited structural information such as the surface and edges may be obtained from the SEM diagram of the silicon-based composite material shown in FIG. 1. However, an internal structure of the 10% silicon-based composite material is not yet clear and requires further characterization.

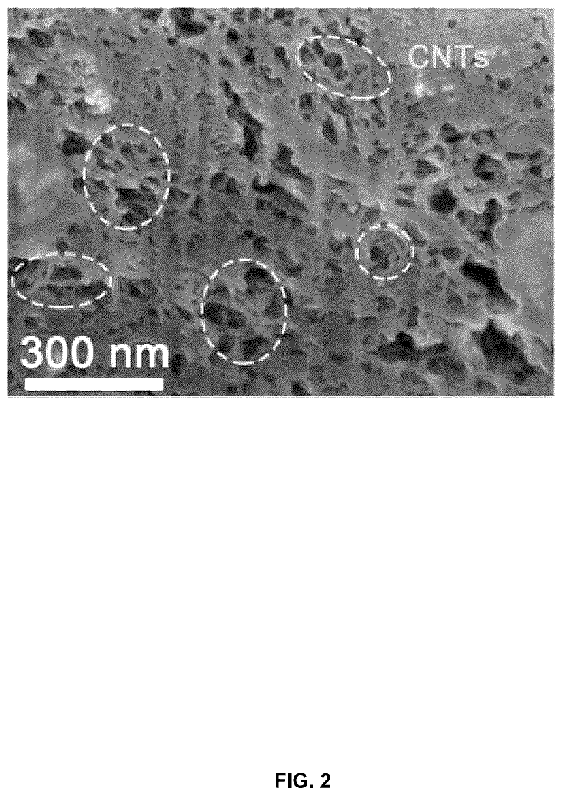

In order to deeply investigate the internal structural information of the 10% silicon-based composite material, its cross-sectional morphology is analyzed using a focused ion beam (FIB), which was combined with SEM to finely characterize the internal morphology and microstructure of the material. It may be clearly seen from FIG. 2 that a large number of multi-walled carbon nanotubes are uniformly distributed on the surface of the material and intertwined and interwoven with each other.

Meanwhile, some of the multi-walled carbon nanotubes wedge into the gaps between the silicon and the carbon and extend inward, which is mainly attributed to the flexibility of the multi-walled carbon nanotubes. Additionally, the composite material is clearly observed in the cross-section as having a hornet's nest structure with a large number of internal voids. This porous structure facilitates the regulation of the volume change of silicon-carbon during charging and discharging.

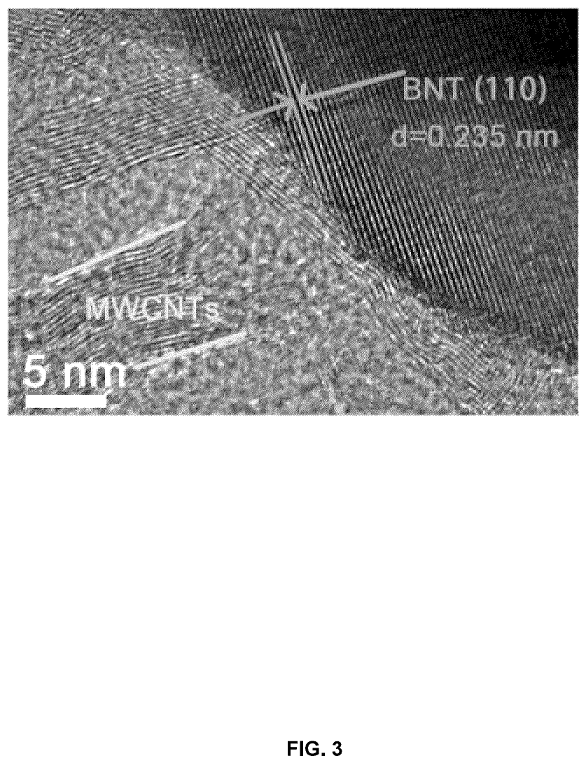

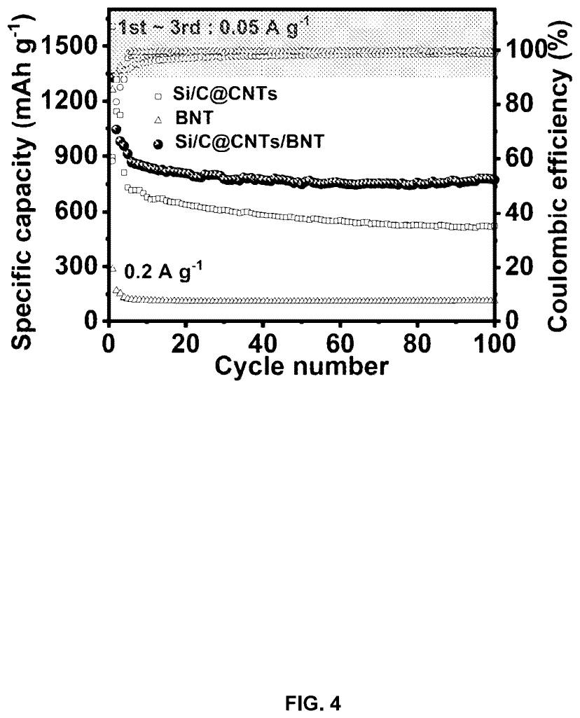

FIG. 3 is a TEM image illustrating a silicon-based composite material according to Embodiment 2 of the present disclosure. An internal atomic arrangement of the sodium bismuth titanate (Bi_{0.5}Na_{0.5})TiO₃ piezoelectric material may be clearly observed, indicating that a crystal structure of the sodium bismuth titanate (Bi_{0.5}Na_{0.5}) TiO₃ piezoelectric material is not damaged after ball milling. A crystal plane distance shown in the figure is measured to be 0.235 nm, corresponding to a crystal plane (110) of the sodium bismuth titanate (Bi_{0.5}Na_{0.5}) TiO₃ piezoelectric material. A region enclosed by solid lines is the multi-walled carbon nanotubes. Charge/Discharge test results show that the 10% silicon-based composite material still maintains a reversible specific capacity of 780.9 mAh g-1 after 100 cycles, with a capacity retention rate of 85.70% in FIG. 4. In comparison, it was found that the electrode of the co-blended material in Comparative embodiment 1 has a rapid capacity decay after 50 cycles, with a capacity retention rate of only 50.09%.

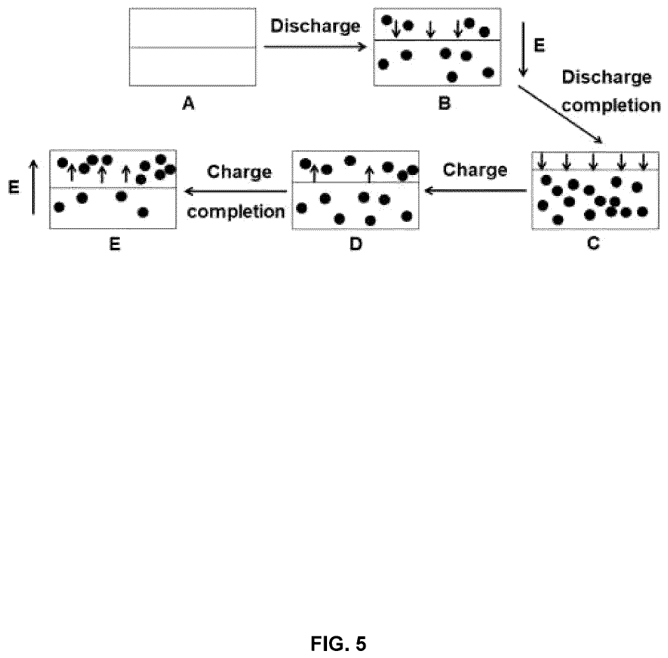

FIG. 5 is a schematic diagram of a surface cladding structure of an anode material of a lithium-ion battery having a piezoelectric effect according to some embodiments of the present disclosure. A represents a state before discharge. An upper layer is a piezoelectric modification layer of the sodium bismuth titanate (Bi_{0.5}Na_{0.5}) TiO₃ piezoelectric material, and a lower layer represents the Si/C anode composite material. B represents a state during the discharge process. In this state, embedded spheres represent lithium ions. When the discharge starts, the lithium ions are embedded into the anode material from the electrolyte and are accompanied by the volume expansion (widening of the lower layer, which produces a squeeze on a piezoelectric coating layer (the upper layer) and generates a piezoelectric potential in the coating layer (arrow in the lower layer). A direction of the piezoelectric potential is downward, which is the same as a diffusion direction of the lithium ions. C represents a state at the end of the discharge. At the end of the discharge, all lithium ions in the anode material are embedded, and the volume expansion is most significant (the lower layer is largest). At this time, the piezoelectric modification layer of the sodium bismuth titanate (Bi_{0.5}Na_{0.5}) TiO₃ piezoelectric material is subjected to the greatest upward mechanical stress, corresponding to a maximum piezoelectric potential inside the coating layer. The direction of the piezoelectric potential at this time is the same as the diffusion direction of lithium ions, which greatly promotes the diffusion and migration of the lithium ions. On the other hand, E represents a charging state. When the charging starts, the lithium ions begin to be dislodged from the piezoelectric coating layer (the lower layer) through the anode material (the upper layer), and a volume of the Si/C anode gradually returns to its original size. The mechanical stress acting on the sodium bismuth titanate (Bi_{0.5}Na_{0.5}) TiO₃ piezoelectric material gradually decreases. However, the gradual disappearance of the external force does not mean the disappearance of the piezoelectric effect. A piezoelectric modification layer of the sodium bismuth titanate (Bi_{0.5}Na_{0.5}) TiO₃ piezoelectric material itself may exist to prevent the disappearance of the piezoelectric effect and to form a reverse piezoelectric electric field, which is just the right way to promote the lithium ions to quickly migrate out of the anode and diffuse to the positive electrode. The volume expansion decreases gradually (the lower layer is getting smaller and smaller), and a pressure on the piezoelectric cladding layer decreases, corresponding to a decrease in the internal piezoelectric potential, but the direction is still upward, consistent with the diffusion direction of the lithium ions and the direction of the applied electric field; F represents the completion of the discharge, at the end of the discharge, most of the lithium ions return to the positive electrode (most of the spheres in the upper layer), and some of them fail to return, corresponding to the anode material failing to return, corresponding to the anode material is unable to return to the original position, compared with the beginning, there is still some expansion (the upper layer is slightly larger than the upper layer of B), there is still pressure on the cladding layer (the lower layer), corresponding to the piezoelectric potential at this time is the smallest, and the direction is consistent with the diffusion direction of the lithium ions and the direction of the applied electric field. Therefore, it can be shown that the piezoelectric coating layer of the sodium bismuth titanate (Bi_{0.5}Na_{0.5}) TiO₃ piezoelectric material provides a driving force for a reversible de-embedding of the lithium ions during the discharge process.

Obviously, those skilled in the art can make various changes and variations to the present disclosure without departing from the spirit and scope of the present disclosure. In this way, to the extent that these modifications and variations of the present disclosure fall within the scope of the claims of the present disclosure and their technical equivalents, it is intended that the present disclosure also encompasses such modifications and variations.

What is claimed is:

1. A silicon-based composite material, comprising a co-blended material having a porous structure, a sodium bismuth titanate (Bi_{0.5}Na_{0.5}) TiO₃ piezoelectric material encapsulated on a surface of the co-blended material, and the co-blended material including a co-blended porous Si/C material and multi-walled carbon nanotubes.

2. The silicon-based composite material of claim 1, wherein the silicon-based composite material includes, in a mass ratio, 5-20% of the sodium bismuth titanate (Bi_{0.5}Na_{0.5}) TiO₃ piezoelectric material, 5-30% of the multi-walled carbon nanotubes, and 65-90% of the porous Si/C material.

3. A method for preparing the silicon-based composite material of claim 1, comprising:
S1, performing a ball milling on a Si/C material with a ball mill for 12-16 h to obtain the porous Si/C material for use;
S2, mixing acidified multi-walled carbon nanotubes with the porous Si/C material obtained from step S1, and then performing the ball milling for 5-8 h to obtain the co-blended material; and
S3, mixing the sodium bismuth titanate (Bi_{0.5}Na_{0.5}) TiO₃ piezoelectric material with the co-blended material obtained from step S2, and then performing the ball milling for 2-4 h to obtain the silicon-based composite material.

4. The method for preparing the silicon-based composite material of claim 3, wherein in step S2, a feeding mass ratio of the porous Si/C material to the multi-walled carbon nanotubes is (8-10): 1.

5. The method for preparing the silicon-based composite material of claim 3, wherein in step S3, a feeding mass ratio of the sodium bismuth titanate (Bi_{0.5}Na_{0.5}) TiO₃ piezoelectric material to the co-blended material is 1: (4-19).

6. The method for preparing the silicon-based composite material of claim 3, wherein the ball milling in steps S1, S2, and S3 are carried out under an inert gas atmosphere.

7. The method for preparing the silicon-based composite material of claim 3, wherein in the ball milling of steps S1, S2 and S3, a ball material ratio is (20-30): 1 and a rotational speed of the ball mill is 700-900 revolutions per minute (rpm).

8. The method for preparing the silicon-based composite material of claim 3, wherein after the ball milling in steps S1, S2, and S3, the method further comprises a step of sieving.

9. The method for preparing the silicon-based composite material of claim 3, wherein the sodium bismuth titanate button (Bi_{0.5}Na_{0.5})TiO₃ piezoelectric material is prepared by a process including: adding Bismuth nitrate pentahydrate, Sodium nitrate and Tetrabutyl titanate to NaOH and stirring uniformly, performing a hydrothermal reaction at 150-170° C. for 40-60 h, and obtaining the sodium bismuth titanate (Bi_{0.5}Na_{0.5}) TiO₃ piezoelectric material.

10. The method for preparing the silicon-based composite material of claim 9, wherein a feeding molar ratio of the Bismuth nitrate pentahydrate, the Sodium nitrate and the Tetrabutyl titanate is (1-2):(2-3):1.

11. An anode material of a lithium-ion battery, comprising the silicon-based composite material of claim 1.

12. A method for preparing the anode material of a lithium-ion battery of claim 11, comprising: dispersing the silicon-based composite material, a conductive agent and a binder in water according to a mass ratio of (7-9):1:1 to obtain a mixed dispersion, coating the mixed dispersion on a copper foil, and drying the mixed dispersion coated on the copper foil to obtain the anode material.

13. A lithium-ion battery, comprising the anode material as claimed in claim 11.
